(19) United States
(12) Patent Application Publication
(10) Pub. No.: US 2020/0367718 A1
(43) Pub. Date: Nov. 26, 2020

(54) ADHESIVE DUST REMOVAL DEVICE

(71) Applicant: Hai Tang LIN, Taichung (TW)

(72) Inventor: Hai Tang LIN, Taichung (TW)

(21) Appl. No.: 16/417,729

(22) Filed: May 21, 2019

(51) Int. Cl. A47L 25/00; B08B 7/00

(52) U.S. Cl. CPC A47L 25/005; B32B 2250/05; B32B 2405/00; B08B 7/0028

(57) ABSTRACT

An adhesive dust removal device includes a base member having a planar base surface, and an adhesive device attached to the base surface of the base member, the adhesive device includes an adhesive paper attached to the base surface of the base member, a release layer attached to the adhesive paper, and the other adhesive papers are attached to the release layer for sticking and removing the dust and the contaminant. It is preferable that the base member includes a parallelepiped structure having the planar base surface, and the adhesive device includes a rectangular structure for attaching to the planar base surface of the base member.

### BACKGROUND OF THE INVENTION

### 1. Field of the Invention

The present invention relates to an adhesive dust removal device, and more particularly to an adhesive dust removal device including an improved structure or configuration for allowing the user to easily cleaning and removing dust and contaminant from corner areas.

### 2. Description of the Prior Art

Typical adhesive dust removal devices comprise an adhesive tape roll sleeve-engaging hollow support cylinder having an integral handle portion extending axially outwardly from one end thereof, and an adhesive tape roll sleeve assembly provided for selective axial slidable covering engagement with the support cylinder so as to be selectively rotatable thereon upon movable contact across a surface being cleaned.

For example, U.S. Pat. No. 4,361,923 to McKay, U.S. Pat. No. 4,422,201 to McKay, and U.S. Pat. No. 4,557,011 to Sartori discloses one of the typical adhesive dust removal devices comprising an adhesive tape roll sleeve assembly for attaching onto or for covering engagement with a roll sleeve-engaging hollow support cylinder so as to be rotatable thereon upon movable contact across a surface being cleaned.

However, the adhesive tape roll sleeve assembly that is attached onto or engaged with a roll sleeve-engaging hollow support cylinder may not be easily engaged into the tiny corner areas in the house family such that the tiny corner areas may not be easily cleaned with the typical adhesive dust removal devices.

The present invention has arisen to mitigate and/or obviate the afore-described disadvantages of the conventional adhesive dust removal devices.

### SUMMARY OF THE INVENTION

The primary objective of the present invention is to provide an adhesive dust removal device including an improved structure or configuration for allowing the user to easily cleaning and removing dust and contaminant from corner areas.

In accordance with one aspect of the invention, there is provided an adhesive dust removal device comprising a base member including a planar base surface, and an adhesive device attached to the base surface of the base member, the adhesive device including a first adhesive paper attached to the base surface of the base member, a release layer attached to the first adhesive paper, and at least one second adhesive paper attached to the release layer for sticking and removing the dust and the contaminant.

The base member includes a parallelepiped structure having the planar base surface formed or provided on the lower or bottom portion thereof. The base member may also be formed into various kinds of shapes or configurations. The adhesive device includes a rectangular structure for attaching to the planar base surface of the base member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a bottom perspective view of an adhesive dust removal device in accordance with the present invention;

FIG. 2 is another bottom perspective view similar to FIG. 1, illustrating the operation of the adhesive dust removal device;

FIG. 3 is a side plan schematic view of the adhesive dust removal device;

FIG. 4 is an enlarged partial side plan schematic view of the adhesive dust removal device as that shown in FIG. 3;

FIGS. 5, 6, 7 are side plan schematic views similar to FIG. 3, illustrating the operation of the adhesive dust removal device; and

FIGS. 8, 9, 10 are enlarged partial side plan schematic views of the adhesive dust removal devices as shown in FIGS. 5, 6, 7 respectively.

### DETAILED DESCRIPTION OF THE PREFERRED EMBODIMENT

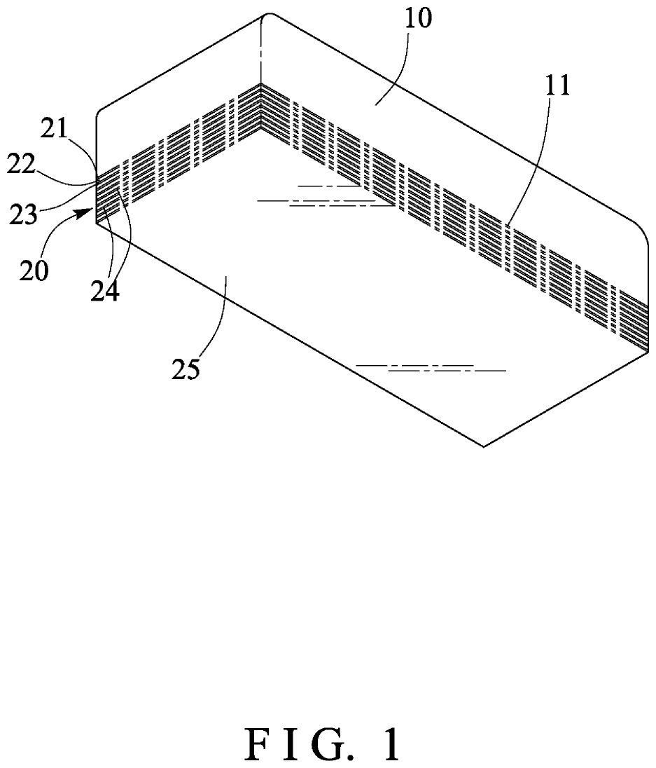

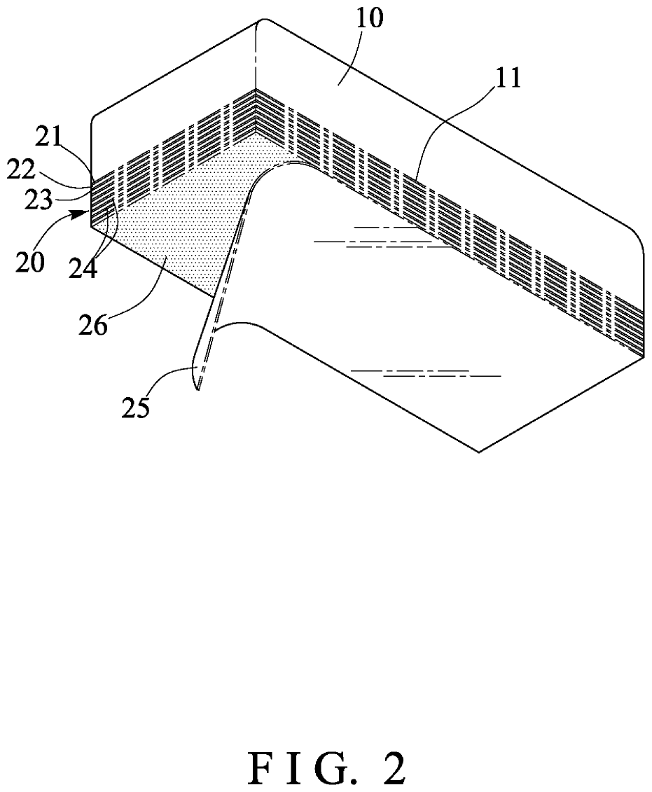

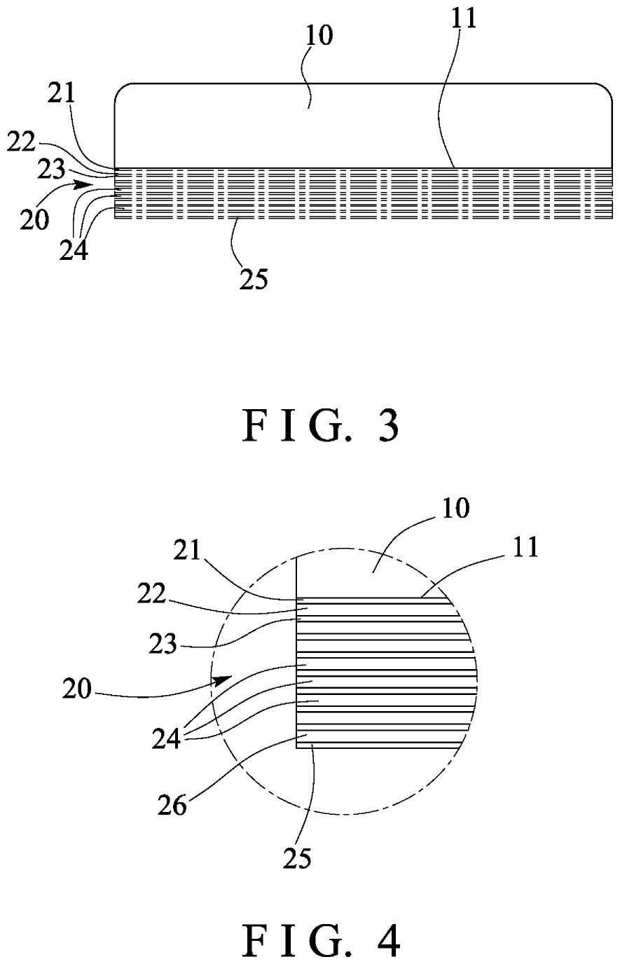

Referring to the drawings, and initially to FIGS. 1-4, an adhesive dust removal device in accordance with the present invention comprises a block body or base member 10 to be gripped or grasped or held by the user, in which the base member 10 includes a substantially parallelepiped structure or configuration having a planar lower or bottom or base surface 11, and an adhesive device 20 is attached or mounted or secured to the base surface 11 of the base member 10 for dust and contaminant cleaning and removing purposes. The adhesive device 20 includes a substantially rectangular structure or configuration.

The adhesive device 20 includes a base release film or layer 21 attached or mounted or secured to the base surface 11 of the base member 10, a first adhesive paper 22 attached or mounted or secured to the base release layer 21, or alternatively, the first adhesive paper 22 may also be directly attached or mounted or secured to the base surface 11 of the base member 10 without the base release layer 21, and one or more release layers 23 and one or more further or second adhesive papers 24 are further provided and attached or mounted or secured to the first adhesive paper 22 alternatively, in which the release layers 23 are disposed or engaged between the first adhesive paper 22 and the further adhesive papers 24 for preventing the adhesive papers 22, 24 from sticking or adhering together.

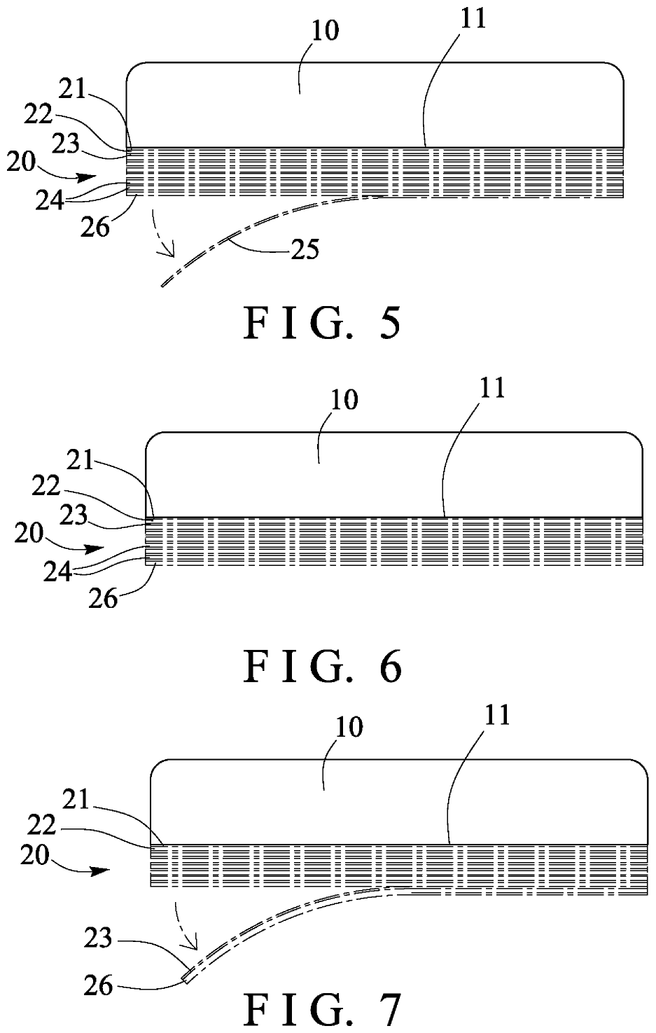

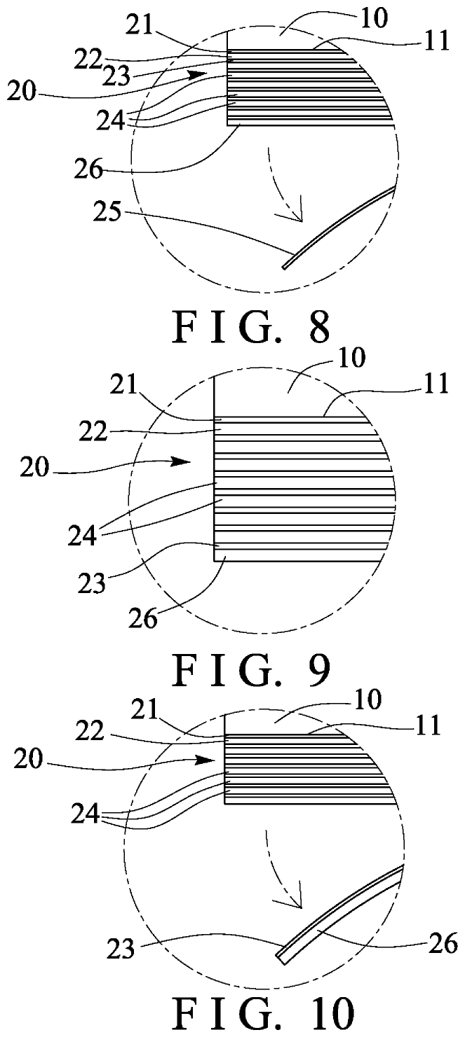

In operation, as shown in FIGS. 1-4, it is preferable that the bottommost layer or portion of the adhesive device 20 is a bottommost release layer 25 for preventing the adhesive papers 22, 24 from sticking or adhering to the other objects or the like. When it is required to use the adhesive papers 22, 24 to stick or adhere and clean and remove the dust and the contaminant or the like, as shown in FIGS. 5 and 8, the bottommost release layer 25 may be released or removed from the bottommost adhesive paper 26, in order to allow the bottommost adhesive paper 26 to be released or opened or exposed, and thus for allowing the bottommost adhesive paper 26 to stick or adhere and remove the dust and the contaminant.

Alternatively, as shown in FIGS. 6-7 and 9-10, when or after the bottommost adhesive paper 26 has been filled with the dust and the contaminant and may not be used for ticking or adhering the other dust or contaminant, and should be removed or detached from the base member 10, the bottommost adhesive paper 26 may be ripped off first and the bottommost release layer 23 that is disposed or located above the bottommost adhesive paper 26 may then be ripped off, or, alternatively, the bottommost adhesive paper 26 and the bottommost release layer 23 may all be removed or detached from the base member 10 together, as shown in FIGS. 7 and 10, for allowing the other or second adhesive papers 24 to be released or opened or exposed, and thus for allowing the other or second adhesive paper 24 to be used for sticking or adhering and removing the dust and the contaminant.

Accordingly, the adhesive dust removal device in accordance with the present invention includes an improved structure or configuration for allowing the user to easily cleaning and removing dust and contaminant from corner areas.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An adhesive dust removal device comprising:
a base member including a planar base surface, and
an adhesive device attached to said base surface of said base member, said adhesive device including:
a first adhesive paper attached to said base surface of said base member,
a release layer attached to said first adhesive paper, and
at least one second adhesive paper attached to said release layer.

2. The adhesive dust removal device as claimed in claim 1, wherein said base member includes a parallelepiped structure having said planar base surface.

3. The adhesive dust removal device as claimed in claim 1, wherein said adhesive device includes a rectangular structure.
